(19) United States
(12) Patent Application Publication
(10) Pub. No.: US 2026/0343460 A1
(43) Pub. Date: Oct. 29, 2026

(54) Service Recovery During Registration With New Radio Network

(71) Applicant: Apple Inc., Cupertino, CA (US)

(72) Inventors: Vinay MYSORE VISWANATH, San Diego, CA (US); Vivek G GUPTA, San Jose, CA (US)

(21) Appl. No.: 19/102,555

(22) PCT Filed: Aug. 9, 2023
(86) PCT No.: PCT/US2023/029838

§ 371 Date: Feb. 10, 2025

Related U.S. Application Data
(60) Provisional application No. 63/371,017, filed on Aug. 10, 2022.

(51) Int. Cl. H04W 60/00; H04W 8/02; H04W 48/18; H04W 84/04

(52) U.S. Cl. CPC H04W 60/002; H04W 8/02; H04W 48/18; H04W 84/042

(57) ABSTRACT

A user equipment (UE) configured to configure transceiver circuitry to transmit a packet data network (PDN) connectivity request to a first network, decode, from signaling received from the first network, an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN), configure transceiver circuitry to transmit a registration request comprising the network slice and a default list of configured network slices to a second network of the PLMN or SNPN and decode, from signaling received from the second network, a registration accept message comprising an indication the registration request for the network slice has been accepted by the second network and a list of configured network slices for the second network.

### PRIORITY/INCORPORATION BY REFERENCE

This application claims priority to U.S. Provisional Application Ser. No. 63/371,017 filed on Aug. 10, 2022, and entitled “Service Recovery During Registration with New Radio Network,” the entirety of which is incorporated herein by reference.

### BACKGROUND

A user equipment (UE) may connect to a network that deploys multiple network slices. Generally, a network slice refers to an end-to-end logical network that is configured to provide a particular service and/or possess particular network characteristics. Each network slice may be isolated from one another but run on a shared network infrastructure. Thus, each network slice may share network resources but facilitate different functionality.

A UE camped on a Long Term Evolution (LTE) network may receive a configured list of network slices for current public land mobile network (PLMN) or Standalone Non-Public Network (SNPN). The UE may then register with a New Radio (NR) network for the same PLMN SNPN. However, the UE will not recognize the configured list of network slices for the LTE network to be valid for the NR network. Thus, the UE will not be able to connect to the network slices on the configured list on the NR network.

### SUMMARY

Some exemplary embodiments are related to an apparatus of a user equipment (UE), the apparatus having processing circuitry configured to configure transceiver circuitry to transmit a packet data network (PDN) connectivity request to a first network, decode, from signaling received from the first network, an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN), configure transceiver circuitry to transmit a registration request comprising the network slice and a default list of configured network slices to a second network of the PLMN or SNPN and decode, from signaling received from the second network, a registration accept message comprising an indication the registration request for the network slice has been accepted by the second network and a list of configured network slices for the second network.

Other exemplary embodiments are related to a processor of a user equipment (UE) configured to configure transceiver circuitry to transmit a packet data network (PDN) connectivity request to a first network, decode, from signaling received from the first network, an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN), configure transceiver circuitry to transmit a registration request comprising the network slice and a default list of configured network slices to a second network of the PLMN or SNPN and decode, from signaling received from the second network, a registration accept message comprising an indication the registration request for the network slice has been accepted by the second network and a list of configured network slices for the second network.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary call flow for an initial registration enabling NR service by registering to slices from a configured NSSAI according to various exemplary embodiments.

FIG. 5 shows an exemplary call flow for a mobility registration enabling NR service by registering to slices from a configured NSSAI according to various exemplary embodiments.

### DETAILED DESCRIPTION

The exemplary embodiments may be further understood with reference to the following description and the related appended drawings, wherein like elements are provided with the same reference numerals. The exemplary embodiments introduce enhancements enabling registration to a configured slice list during initial registration or mobility registration to a NR network.

The exemplary embodiments are described with regard to a UE. However, the use of the term “UE” is merely for illustrative purposes. The exemplary embodiments may be utilized with any electronic component that may establish a connection with a network and is configured with the hardware, software, and/or firmware to exchange information and data with the network. Therefore, the UE as described herein is used to represent any suitable electronic component.

The exemplary embodiments are also described with regard to a fifth generation (5G) network and an LTE network that support network slicing. Generally, network slicing refers to a network architecture in which multiple end-to-end logical networks run on a shared physical network infrastructure. Each network slice may be configured to provide a particular set of capabilities and/or characteristics. Thus, the physical infrastructure of the 5G network or the LTE network may be sliced into multiple virtual networks, each configured for a different purpose. Throughout this description, reference to a network slice may represent any type of end-to-end logical network that is configured to serve a particular purpose and implemented on the 5G or LTE physical infrastructure.

In addition, throughout this description it should be understood that different radio access networks (RANs) may connect to the same core network. For example, a 5G RAN may connect to a 5G core network (5GC) and an LTE-RAN may also connect to the same 5GC. In another example, the 5G RAN may connect to the 5GC and LTE-RAN may connect to the LTE core network (Evolved Packet Core (EPC)). It should be understood that the exemplary embodiments may be implemented in any of these core network connection scenarios and the scenarios described below are only exemplary.

Throughout this description, specific messages with specific message names are referenced as being exchanged between the UE and the network. For example, when a UE receives a REGISTRATION ACCEPT message, the UE is connected to a 5G network and when it receives an ACTIVATE BEARER CONTEXT REQUEST message or an ACTIVATE DEAFAULT EPS BEARER CONTEXT REQUEST message, the UE is connected to an LTE network. However, it should be understood that these messages and message names are only exemplary and the messages carrying the described information may be referred to by different names.

A network slice may be identified by single network slice selection assistance information (S-NSSAI). Each instance of S-NSSAI may be associated with a public land mobile network (PLMN). Throughout this description, S-NSSAI refers to a single network slice and the terms “NSSAI” or “S-NSSAIS” may be used interchangeably to refer to one or more network slices.

The UE may be configured to perform any of a wide variety of different tasks. Thus, the UE may be configured to utilize one or more network slices. To provide an example, the UE may utilize a first network slice for one or more carrier services (e.g., voice, multimedia messaging service (MMS), Internet, etc.) and a second different network slice for a third-party service. However, the configured purpose of a network slice is beyond the scope of the exemplary embodiments. The exemplary embodiments are not limited to any particular type of network slice.

The examples described herein may reference the terms “allowed NSSAI,” “configured NSSAI,” “requested NSSAI” and “rejected NSSAI.” Prior to discussing the exemplary enhancements, a brief description of each these terms and how they may relate to one another is provided below.

Those skilled in the art will understand that the term “allowed NSSAI” refers to S-NSSAIs provided by the network that the UE may utilize in a serving PLMN for a particular registration area. As will be described in more detail below, the allowed NSSAI may be provided by the network to the UE during a registration procedure. Due to the relationship between registration and allowed NSSAI, in some embodiments, the term “registered network slice” may be used interchangeably with allowed NSSAI to refer to the same concept.

To track the allowed NSSAI, the UE may operate an allowed NSSAI list stored locally at the UE or may utilize any other appropriate mechanism. The number of network slices that may be considered allowed NSSAI for the UE may be limited to a predetermined maximum number of allowed NSSAI. For example, some 3GPP Specifications may limit the maximum number of allowed NSSAI to a length of 8 S-NSSAI. In some scenarios, when a S-NSSAI is stored locally as an allowed NSSAI, the UE may attempt to establish a packet data unit (PDU) session on the S-NSSAI. However, when the S-NSSAI is not considered part of the allowed NSSAI, the UE may ignore upper layer requests for the S-NSSAI and PDU session establishment on the network slice may not be initiated by the UE.

Those skilled in the art will understand that the term “configured NSSAI” refers to S-NSSAIs provisioned in the UE and applicable to one or more PLMNs. To track the configured NSSAI, the UE may operate a configured NSSAI list stored locally at the UE or may utilize any other appropriate mechanism. When a network slice is stored locally as configured NSSAI, the value of the S-NSSAI is known to the UE. When a network slice is not stored locally as configured NSSAI, the UE may not know the value of the S-NSSAI. The number of configured NSSAI may be limited to a predetermined maximum number of configured NSSAI. For example, some 3GPP Specifications may limit the maximum number of configured NSSAI to a length of 16 S-NSSAI. In some embodiments, the term “subscribed network slice” may be used interchangeably with configured NSSAI to refer to the same concept.

During operation, the number of configured NSSAI stored locally at the UE may be greater than the number of allowed NSSAI stored locally at the UE. Thus, there may be one or more S-NSSAIs considered by the UE to be configured NSSAI but not part of the allowed NSSAI. For example, S-NSSAI-A may be part of the configured NSSAI list stored locally at the UE but not part of the allowed NSSAI list stored locally at the UE. In this type of arrangement, the UE may not initiate PDU session establishment on S-NSSAI-A because S-NSSAI-A is not part of the allowed NSSAI list. Throughout this description, any reference to “S-NSSAI-A” is merely provided to differentiate one network slice from other network slices and is not intended to limit the exemplary embodiments in any way.

Those skilled in the art will understand that the term “requested NSSAI” refers to NSSAI provided to the network by the UE during a registration procedure. The network may then determine whether the UE is permitted to register to each requested S-NSSAI. For example, the UE may store S-NSSAI-A as part of the configured NSSAI. The UE may then transmit a registration request to the network indicating that the UE wants to register to one or more network slices, e.g., S-NSSAI-A, etc. In response, the network may indicate that the requested S-NSSAI(s) is allowed NSSAI. The UE may then store the S-NSSAI-A in the allowed NSSAI list.

Alternatively, in response to the requested NSSAI, the network may indicate that the request for S-NSSAI-A is rejected. The UE may then consider S-NSSAI-A to be “rejected NSSAI.” To track rejected NSSAI, the UE may operate a rejected NSSAI list stored locally at the UE or may utilize any other appropriate mechanism. In some scenarios, the UE may be configured to omit or ignore rejected NSSAI during other operations and/or procedures. For example, under certain conditions, the UE may not attempt to register on a network slice that is stored locally as part of the rejected NSSAI.

The above examples provide a general overview of the relationship between the terms “allowed NSSAI,” “configured NSSAI,” “requested NSSAI” and “rejected NSSAI.” These examples are not intended to limit the scope of these terms or the exemplary embodiments in any way.

Some exemplary embodiments are related to enabling registration to a default configured NSSAI list under certain conditions. These exemplary embodiments allow a UE to send a default configured NSSAI list during initial registration or mobility registration with an NR network and allows the NR network to send the configured slice list to the UE.

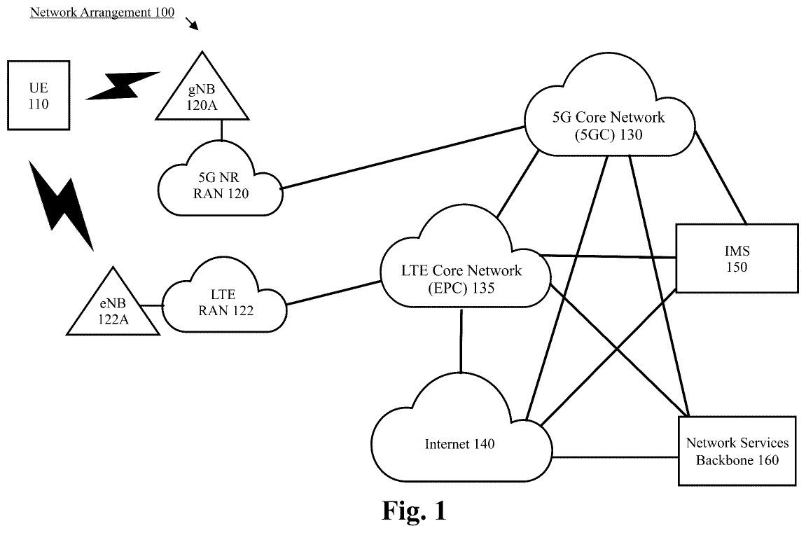

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120 and an LTE-RAN 122. However, the UE 110 may also communicate with other types of networks (e.g., 5G cloud RAN, a next generation RAN (NG-RAN), a legacy cellular network, a wireless local area network (WLAN), etc.) and the UE 110 may also communicate with networks over a wired connection. With regard to the exemplary embodiments, the UE 110 may establish a connection with the 5G NR RAN 120 or the LTE-RAN 122. Therefore, the UE 110 may have a 5G NR chipset to communicate with the 5G NR RAN 120 and an LTE chipset to communicate with the LTE-RAN 122.

The 5G NR RAN 120 and the LTE-RAN 122 may be a portion of a cellular network that may be deployed by a network carrier (e.g., Verizon, AT&T, T-Mobile, etc.). The 5G NR RAN 120 and LTE-RAN 122 may include, for example, nodes, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The network arrangement 100 also includes a corresponding cellular core network for each of the 5G NR RAN 120 and LTE-RAN 122. This may include the fifth generation core (5GC) 130 and the evolved packet core (EPC) 135. The cellular core networks 130, 135 may refer an interconnected set of components that manages the operation and traffic of the cellular network. The cellular core networks 130, 135 also manages the traffic that flows between the cellular networks and the Internet 140.

Those skilled in the art will understand that any association procedure may be performed for the UE 110 to connect to the 5G NR-RAN 120 and/or the LTE-RAN 122. For example, as discussed above, the 5G NR-RAN 120 and/or the LTE-RAN 122 may be associated with a particular cellular provider where the UE 110 and/or the user thereof has a contract and credential information (e.g., stored on a SIM card). Upon detecting the presence of the 5G NR-RAN 120 and/or the LTE-RAN 122, the UE 110 may transmit the corresponding credential information to associate with the 5G NR-RAN 120 and/or the LTE-RAN 122. More specifically, the UE 110 may associate with a specific base station, e.g., the next generation Node B (gNB) 120A of the 5G NR RAN 120 or the evolved Node B (eNB) 122A of the LTE-RAN 122.

The network arrangement 100 also includes the Internet 140, an IP Multimedia Subsystem (IMS) 150, and a network services backbone 160. The IMS 150 may be generally described as an architecture for delivering multimedia services to the UE 110 using the IP protocol. The IMS 150 may communicate with the cellular core networks 130, 135 and the Internet 140 to provide the multimedia services to the UE 110. The network services backbone 160 is in communication either directly or indirectly with the Internet 140 and the cellular core networks 130, 135. The network services backbone 160 may be generally described as a set of components (e.g., servers, network storage arrangements, etc.) that implement a suite of services that may be used to extend the functionalities of the UE 110 in communication with the various networks.

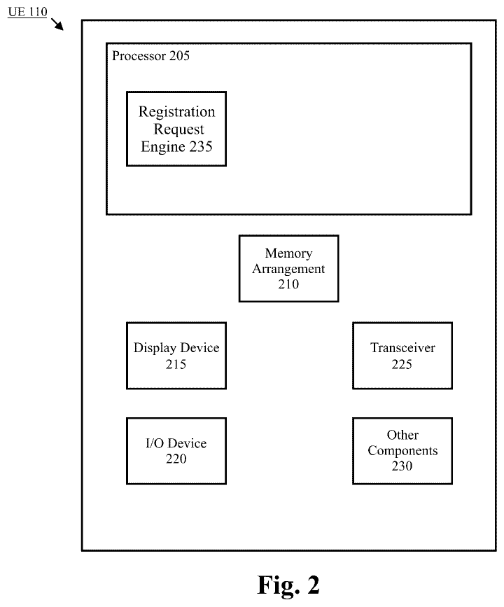

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a registration request engine 235. The registration request engine 235 may perform operations related to the UE 110 performing a registration operation (initial registration or mobility registration) with the 5G NR RAN 120 such that a configured slice list may be used by the UE 110. The exemplary operations are described in greater detail below.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e. g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

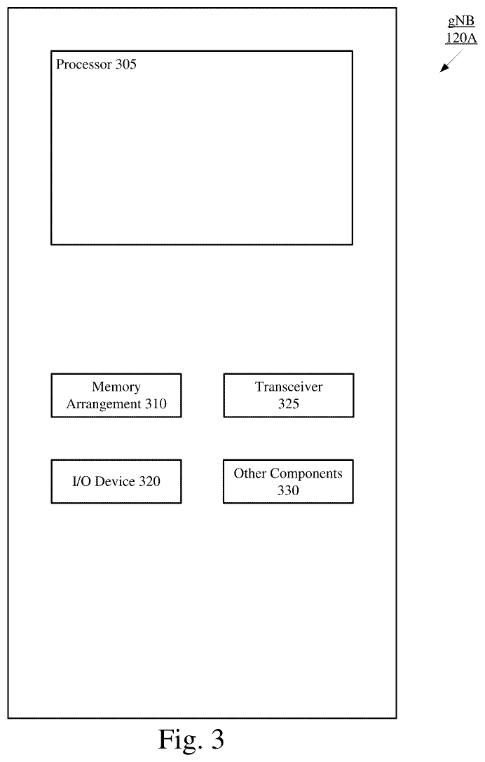

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. The engines being an application (e.g., a program) executed by the processor 305 is only exemplary. The functionality associated with the engines may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e. g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As described above, some exemplary embodiments are directed to enabling NR service by registering to slices from a configured NSSAI. Prior to describing enabling NR service by registering to slices from a configured NSSAI, an exemplary scenario will be described to show the issue that the exemplary embodiments resolve.

In the exemplary scenario, the UE 110 powers on and attaches to a home PLMN (HPLMN) on the EPC 130 without any stored configured NSSAI. The UE 110 receives S-NSSAI_1 associated with the HPLMN during the PDN connection establishment procedure in the evolved packet system (EPS) and adds S-NSSAI_1 to the configured NSSAI list for the HPLMN. The UE 110 then performs an intersystem change from S1 mode (LTE) to N1 mode (NR) and sends a mobility REGISTRATION REQUEST with only S-NSSAI_1 as part of requested NSSAI. The UE 110 then receives a REGISTRATION ACCEPT message with S-NSSAI_1 as part of the allowed NSSAI but does not receive configured NSSAI from the 5GC 130. Since the UE 110 does not receive configured NSSAI from the 5GC 130, the UE 110 will not be able to register slices by using configured NSSAI of the HPLMN and thus will not be able to use these slices.

The exemplary embodiments provide a solution to this issue by allowing the UE 110 to send default configured NSSAI in requested NSSAI of a registration request to the network (e.g., 5GC 130) if the configured NSSAI in the UE 110 only contains S-NSSAIs received in the EPC 135 via ePCO.

This solution may be expressed as follows for initiation of an initial registration attempt for the 5GC 130. If the UE has no allowed NSSAI for the current PLMN or SNPN and/or no configured NSSAI for the current PLMN or SNPN or the configured NSSAI contains only the S-NSSAIs received from the network during the PDN connection establishment procedure in EPS or via evolved packet data gateway (ePDG) and has a default configured NSSAI, then the UE shall a) include the S-NSSAI(s) in the Requested NSSAI IE of the REGISTRATION REQUEST message using the default configured NSSAI; and b) include the Network slicing indication IE with the Default configured NSSAI indication bit set to “Requested NSSAI created from default configured NSSAI” in the REGISTRATION REQUEST message.

This solution may be expressed as follows for initiation of mobility and periodic registration updates for the 5GC 130. If the UE has no allowed NSSAI for the current PLMN or SNPN, no configured NSSAI for the current PLMN or SNPN or the configured NSSAI contains only the S-NSSAIs received from the network during the PDN connection establishment procedure in EPS or via ePDG, neither active PDU session(s) nor PDN connection(s) to transfer associated with an S-NSSAI applicable in the current PLMN or SNPN and neither active PDU session(s) nor PDN connection(s) to transfer associated with mapped S-NSSAI(s) and has a default configured NSSAI, then the UE shall a) include the S-NSSAI(s) in the Requested NSSAI IE of the REGISTRATION REQUEST message using the default configured NSSAI and b) include the Network slicing indication IE with the Default configured NSSAI indication bit set to “Requested NSSAI created from default configured NSSAI” in the REGISTRATION REQUEST message.

The following provides exemplary flow diagrams illustrating this enabling NR service by registering to slices from a configured NSSAI.

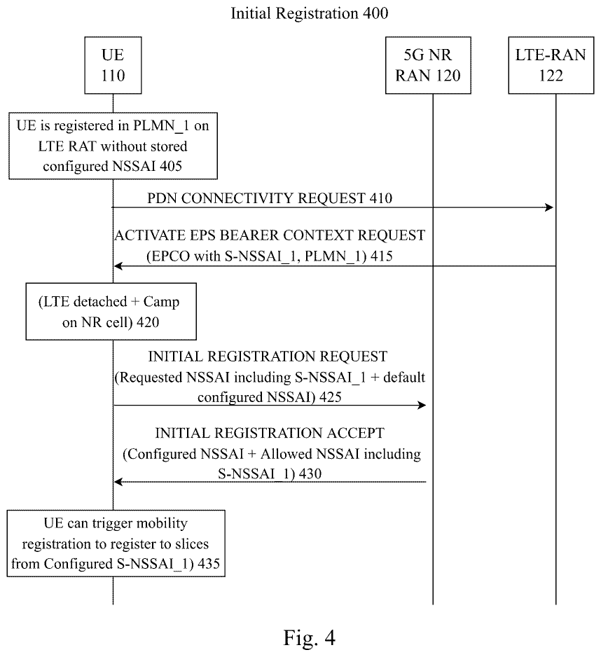

FIG. 4 shows an exemplary call flow 400 for an initial registration enabling NR service by registering to slices from a configured NSSAI according to various exemplary embodiments. The exemplary call flow is performed between the UE 110, the 5GC 130 and the EPC 135.

In 405, it may be considered that the UE 110 is registered in PLMN_1 on the EPC 135 without a stored configured NSSAI. In 410, the UE 110 sends a PDN connectivity request to the EPC 135. In 615, the LTE-RAN 122 activates an EPS bearer context request including ePCO with S-NSSAI_1 for PLMN_1.

In 420, the UE 110 detaches from the EPC 135 and camps the 5GC 130. In 425, the UE 110 sends an initial REGISTRATION REQUEST to the 5GC 130 with requested NSSAI including S-NSSAI_1 and the default configured NSSAI, e.g., the conditions described above are satisfied such that the UE 110 is allowed to send the default configured NSSAI to the 5GC 130. In 430, the UE 110 receives from the 5GC 130 an initial REGISTRATION ACCEPT message with allowed NSSAI including S-NSSAI_1 and the configured NSSAI. Thus, in 435, the UE 110 may trigger a mobility registration to register to slices that are included on the configured NSSAI.

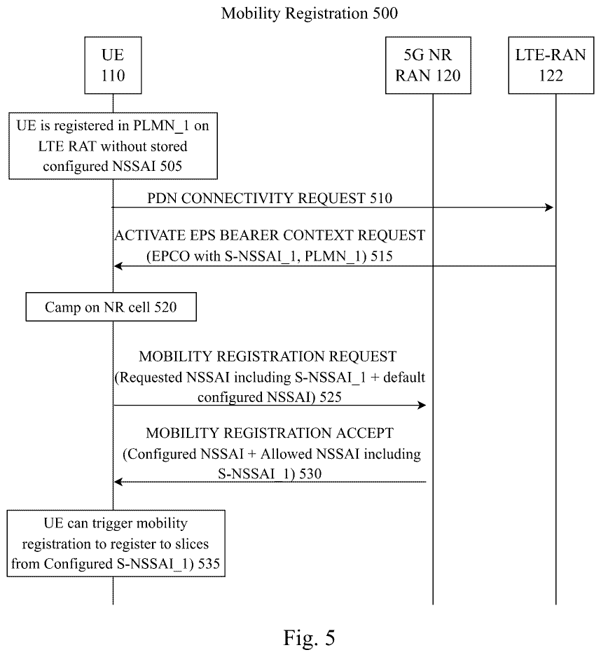

FIG. 5 shows an exemplary call flow 500 for a mobility registration enabling NR service by registering to slices from a configured NSSAI according to various exemplary embodiments. The exemplary call flow is performed between the UE 110, the 5GC 130 and the EPC 135.

In 505, it may be considered that the UE 110 is registered in PLMN_1 on the EPC 135 without a stored configured NSSAI. In 510, the UE 110 sends a PDN connectivity request to the EPC 135. In 515, the EPC 135 activates an EPS bearer context request (e.g., ACTIVATE DEAFAULT EPS BEARER CONTEXT REQUEST) including ePCO with S-NSSAI_1 for PLMN_1.

In 520, the UE 110 camps on the 5GC 130. In 525, the UE 110 sends a mobility REGISTRATION REQUEST to the 5GC 130 with requested NSSAI including S-NSSAI_1 and the default configured NSSAI, e.g., the conditions described above are satisfied such that the UE 110 is allowed to send the default configured NSSAI to the 5GC 130. In 530, the UE 110 receives from the 5GC 130 a mobility REGISTRATION ACCEPT message with allowed NSSAI including S-NSSAI_1 and the configured NSSAI. Thus, in 535, the UE 110 may trigger a mobility registration to register to slices that are included on the configured NSSAI.

### EXAMPLES

In a first example, a method performed by a user equipment (UE), comprising transmitting a packet data network (PDN) connectivity request to a first network, receiving an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN), transmitting a registration request comprising the network slice and a default list of configured network slices to a second network of the PLMN or SNPN and receiving a registration accept message comprising an indication the registration request for the network slice has been accepted by the second network and a list of configured network slices for the second network.

In a second example, the method of the first example, wherein the registration request comprises an initial registration request for the second network.

In a third example, the method of the second example, wherein transmitting the default list of configured network slices is based on the UE having no configured network slices for the second network of the PLMN or SNPN.

In a fourth example, the method of the second example, wherein transmitting the default list of configured network slices is based on the UE having configured network slices that contain only the network slice received from the first network in the activate default EPS bearer context request message.

In a fifth example, the method of the first example, wherein the registration request comprises a mobility registration request for the second network.

In a sixth example, the method of the fifth example, wherein transmitting the default list of configured network slices is based on the UE having configured network slices that contain only the network slice received from the first network in the activate default EPS bearer context request message.

In a seventh example, the method of the first example, wherein the first network is a Long Term Evolution (LTE) network and second network is a Fifth Generation New Radio (5G NR) network.

In an eighth example, a processor configured to perform any of the methods of the first through seventh examples.

In a ninth example, a user equipment (UE) comprising a transceiver configured to communicate with a network and a processor communicatively coupled to the transceiver and configured to perform any of the methods of the first through seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
configure transceiver circuitry to transmit a packet data network (PDN) connectivity request to a first network;
decode, from signaling received from the first network, an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN);
configure transceiver circuitry to transmit a registration request comprising the network slice and a default list of configured network slices to a second network of the PLMN or SNPN; and
decode, from signaling received from the second network, a registration accept message comprising an indication the registration request for the network slice has been accepted by the second network and a list of configured network slices for the second network.

2. The apparatus of claim 1, wherein the registration request comprises an initial registration request for the second network.

3. The apparatus of claim 2, wherein transmitting the default list of configured network slices is based on the UE having no configured network slices for the second network of the PLMN or SNPN.

4. The apparatus of claim 2, wherein transmitting the default list of configured network slices is based on the UE having configured network slices that contain only the network slice received from the first network in the activate default EPS bearer context request message.

5. The apparatus of claim 1, wherein the registration request comprises a mobility registration request for the second network.

6. The apparatus of claim 5, wherein transmitting the default list of configured network slices is based on the UE having configured network slices that contain only the network slice received from the first network in the activate default EPS bearer context request message.

7. The apparatus of claim 1, wherein the first network is a Long Term Evolution (LTE) network and second network is a Fifth Generation New Radio (5G NR) network.

8. A processor of a user equipment (UE) configured to:
configure transceiver circuitry to transmit a packet data network (PDN) connectivity request to a first network;
decode, from signaling received from the first network, an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN);
configure transceiver circuitry to transmit a registration request comprising the network slice and a default list of configured network slices to a second network of the PLMN or SNPN; and
decode, from signaling received from the second network, a registration accept message comprising an indication the registration request for the network slice has been accepted by the second network and a list of configured network slices for the second network.

9. The processor of claim 8, wherein the registration request comprises an initial registration request for the second network.

10. The processor of claim 9, wherein transmitting the default list of configured network slices is based on the UE having no configured network slices for the second network of the PLMN or SNPN.

11. The processor of claim 9, wherein transmitting the default list of configured network slices is based on the UE having configured network slices that contain only the network slice received from the first network in the activate default EPS bearer context request message.

12. The processor of claim 8, wherein the registration request comprises a mobility registration request for the second network.

13. The processor of claim 12, wherein transmitting the default list of configured network slices is based on the UE having configured network slices that contain only the network slice received from the first network in the activate default EPS bearer context request message.

14. A method performed by a user equipment (UE), comprising:
transmitting a packet data network (PDN) connectivity request to a first network;
receiving an activate default evolved packet system (EPS) bearer context request message comprising an Extended Protocol Configuration Option (ePCO) indicating the UE can access a network slice on a Public Land Mobile Network (PLMN) or a Standalone Non-Public Network (SNPN);
transmitting a registration request comprising the network slice and a default list of configured network slices to a second network of the PLMN or SNPN; and
receiving a registration accept message comprising an indication the registration request for the network slice has been accepted by the second network and a list of configured network slices for the second network.

15. The method of claim 14, wherein the registration request comprises an initial registration request for the second network.

16. The method of claim 15, wherein transmitting the default list of configured network slices is based on the UE having no configured network slices for the second network of the PLMN or SNPN.

17. The method of claim 15, wherein transmitting the default list of configured network slices is based on the UE having configured network slices that contain only the network slice received from the first network in the activate default EPS bearer context request message.

18. The method of claim 14, wherein the registration request comprises a mobility registration request for the second network.

19. The method of claim 18, wherein transmitting the default list of configured network slices is based on the UE having configured network slices that contain only the network slice received from the first network in the activate default EPS bearer context request message.

20. The method of claim 14, wherein the first network is a Long Term Evolution (LTE) network and second network is a Fifth Generation New Radio (5G NR) network.
